(19) United States
(12) Patent Application Publication
(10) Pub. No.: US 2009/0110961 A1
(43) Pub. Date: Apr. 30, 2009

(54) MAGNETIC RECORDING MEDIUM, METHOD OF MANUFACTURING THE SAME, AND MAGNETIC STORAGE DEVICE

(75) Inventors: Hisato Shibata, Higashine (JP); Hideaki Takahoshi, Higashine (JP); Shinya Sato, Higashine (JP); Isatake Kaitsu, Higashine (JP); Akira Kikuchi, Higashine (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/260,431

(22) Filed: Oct. 29, 2008

(30) Foreign Application Priority Data
Oct. 30, 2007 (JP) 2007-282525

(51) Int. Cl. G11B 5/62

(52) U.S. Cl. 428/828

(57) ABSTRACT

A magnetic recording medium used for a hard disc drive and the like, a method of manufacturing the same, and a magnetic storage device. The magnetic recording medium that includes a substrate, a first ferromagnetic layer formed on the substrate, a non-magnetic layer formed on the first ferromagnetic layer and including a ferromagnetic element and a second ferromagnetic layer formed on the non-magnetic layer, wherein the first ferromagnetic layer and the second ferromagnetic layer are magnetically coupled through the non-magnetic layer.

### CROSS-REFERENCE TO RELATED APPLICATIONS

This application claims the benefit of priority from Japanese Patent Application No. 2007-282525 filed on Oct. 30, 2007, which is herein incorporated by reference in its entirety.

### BACKGROUND

1. Field of the Invention

Example embodiments discussed herein are related to a magnetic recording medium used for a hard disc drive and the like, a method of manufacturing the same, and a magnetic storage device.

2. Description of the Related Art

The recording density of magnetic storage devices such as a magnetic disc device has been substantially increased by applying a read head element using a tunneling magneto-resistive effect element thereto and employing a perpendicular magnetic recording medium. However, the trend is to further increase the recording density of magnetic storage devices.

One way to increase the recording density is to reduce the noise of the perpendicular magnetic recording medium. To cope with the noise issue, researches for miniaturizing magnetic crystal grains and for a recording layer having a granular structure have been conducted. For example, in a recording layer having a granular structure, the magnetic coupling between the magnetic crystal grains is reduced by a non-magnetic material. However, when magnetic crystal grains are miniaturized or a recording layer having the granular structure is employed, stability against thermal agitation is deteriorated, and it is difficult to keep a recorded magnetization direction. Other materials have been considered for fabricating a granular recording layer, such as any material having magnetic energy stable to thermal agitation. However, with such a material, it is difficult to cause magnetization reversal by an external magnetic field used for writing data to the recording layer. That is, it is difficult to overwrite data on the recording layer.

As described above, in a conventional perpendicular magnetic recording medium, it is difficult to make overwrite characteristics and thermal stability compatible.

Japanese Patent Application Laid-Open No. 2006-48900 (JPA 2006-48900) discloses a perpendicular magnetic recording medium in which a non-magnetic layer includes Ru is interposed between magnetic recording layers having a granular structure. Such a perpendicular magnetic recording medium is operable to improve overwrite characteristics and thermal stability.

However, to provide good magnetic coupling between the magnetic recording layers, the thickness of the non-magnetic layer typically controlled to be in a narrow range. When the thickness is outside of the range, desired characteristics may not be obtained. In particular, because the thickness of the non-magnetic layer is set to as thin as about 0.1 nm, it is difficult to control the thickness. Thus, the device and method described in JPA 2006-48900 may not be suitable for mass production because the thickness of the non-magnetic layer has a narrow margin for error, and it is difficult to control such a thickness.

### SUMMARY

At least one embodiment as described herein provides a magnetic recording medium that is operable to provide compatibility between overwrite characteristics and thermal stability, and also is suitable for mass production.

In accordance with various example embodiments described herein, a magnetic recording medium includes a substrate, a first ferromagnetic layer formed on the substrate, a non-magnetic layer formed on the first ferromagnetic layer and including a ferromagnetic element and a second ferromagnetic layer formed on the non-magnetic layer, the first ferromagnetic layer and the second ferromagnetic layer being magnetically coupled through the non-magnetic layer.

Other features and advantages of embodiments of the invention are apparent from the detailed specification and, thus, are intended to fall within the scope of the appended claims. Further, because numerous modifications and changes will be apparent to those skilled in the art based on the description herein, it is not desired to limit the embodiments of the invention to the exact construction and operation illustrated and described, and accordingly all suitable modifications and equivalents are included.

### BRIEF DESCRIPTION OF THE DRAWINGS

FIG. 1 is a sectional view showing a structure of a perpendicular magnetic recording medium according to an example embodiment of the present invention;

FIG. 2 is a view showing how the perpendicular magnetic recording medium according to an example embodiment of the present invention is used;

FIG. 3 is a view showing an internal arrangement of a hard disc drive (HDD) according to an example embodiment of the present invention;

FIG. 4 is a graph showing a result of a second experiment according to an example embodiment of the present invention; and

FIG. 5 is a graph showing a result of a third experiment according to an example embodiment of the present invention.

### DETAILED DESCRIPTION OF EXAMPLE EMBODIMENTS

Among other things, the following description discusses ranges. All ranges including the term “about” should also be understood as describing the corresponding ranges without the term “about” as an alternative embodiment of the same. For example, the range from about 5% to about 10% includes the range from 5% to 10%.

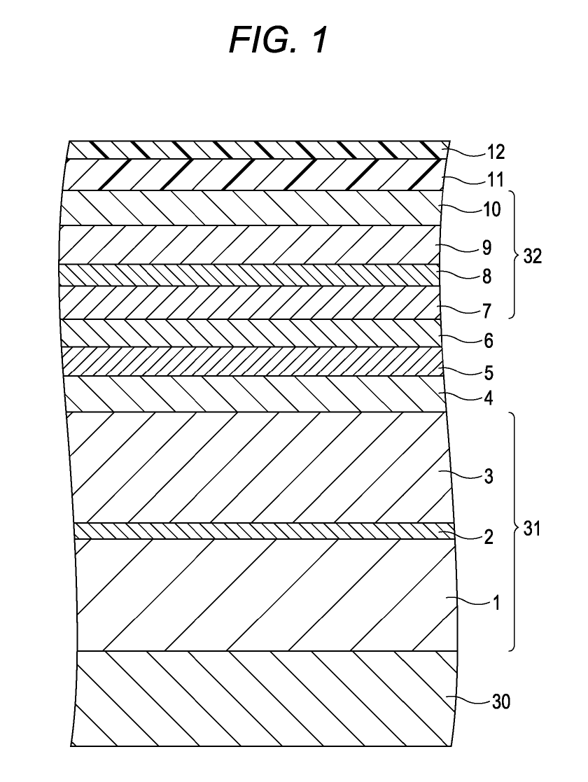

An embodiment of the present invention will be specifically explained below referring to the accompanying drawings. FIG. 1 is a sectional view showing a structure of a perpendicular magnetic recording medium according to an example embodiment of the present invention.

In the example embodiment, a soft magnetic layer 1, a non-magnetic layer 2, and a soft magnetic layer 3 are laminated on a disc-shaped non-magnetic substrate 30 in this order as shown in FIG. 1. A soft magnetic underlayer 31 includes the soft magnetic layer 1, the non-magnetic layer 2, and the soft magnetic layer 3.

A plastic substrate, a crystallized glass substrate, a reinforced glass substrate, an Si substrate, an aluminum alloy substrate, and the like, for example, are used as the non-magnetic substrate 30.

A soft magnetic layer having an amorphous structure or a fine crystal structure including, for example, Fe, Co, Ni, and the like is formed as the soft magnetic layers 1 and 3. W, Hf, C, Cr, B, Cu, Ti, V, Nb, Zr, Pt, Pd, and Ta may be added to these elements. For example, a Fe—Co—Nb—Zr layer, a Co—Zr—Nb layer, a Co—Nb—Ta layer, a Fe—Co—Zr—Nb layer, a Fe—Co—Zr—Ta layer, a Fe—Co—B layer, a Fe—Co—Cr—B layer, a Ni—Fe—Si—B layer, a Fe—Al—Si layer, a Fe—Ta—C layer, a Fe—Hf—C layer, a Ni—Fe layer, or the like may be used as the layer having the amorphous structure or the fine crystal structure. In particular, a layer including a soft magnetic material having a saturation magnetic flux density Bs of 1.0 T or more is preferable in consideration of the concentration of a write magnetic field. The soft magnetic layers 1 and 3 may be formed by, for example, plating, DC sputtering, RF sputtering, pulse DC sputtering, vapor deposition, CVD (chemical vapor deposition), and the like. The thickness of the soft magnetic layers 1 and 3 is, for example, from about 20 nm to about 30 nm. When the thickness of the soft magnetic layers 1 and 3 is less than about 25 nm, insufficient record/reproduction characteristics may be caused. Whereas, when the thickness of the soft magnetic layers 1 and 3 exceeds about 30 nm, a large mass production facility may be required or a cost may be outstandingly increased.

A non-magnetic metal layer that includes, for example, Ru or a Ru alloy is formed as the non-magnetic layer 2. The non-magnetic layer 2 may be also formed by, for example, plating, DC sputtering, RF sputtering, pulse DC sputtering, vapor deposition, CVD, or the like. The thickness of the non-magnetic layer 2 is set to such a thickness that antiparallel magnetic coupling is formed between the soft magnetic layers 1 and 3 (for example, from about 0.5 nm to about 1 nm). That is, since the soft magnetic layers 1 and 3 are magnetized in an opposite direction, anti-ferromagnetic coupling appears between the soft magnetic layers 1 and 3. Note that Re, Cr, Rh, Ir, Cu, V, or the like may be used as the material of the non-magnetic layer 2, e.g., as disclosed in S. S. P. Parkin, Phy. Rev. Lett. 67, 3598 (1991).

In the soft magnetic underlayer 31 described above, the formation of a magnetic domain and a magnetic domain wall is suppressed.

A nickel alloy intermediate layer 4 is formed on the soft magnetic underlayer 31. The nickel alloy intermediate layer 4, for example, includes Ni—W, Ni—Cr or Ni—Cr—W. Further, these alloys may include an additive such as B or C. The nickel alloy intermediate layer 4 may be also formed by, for example, plating, DC sputtering, RF sputtering, pulse DC sputtering, vapor deposition, CVD, or the like. The thickness of the nickel alloy intermediate layer 4 is, for example, from about 3 nm to about 10 nm.

A Ru intermediate layer 5 is formed on the nickel alloy intermediate layer 4. The Ru intermediate layer 5 includes of Ru or a Ru alloy. The Ru intermediate layer 5 may be also formed by, for example, plating, DC sputtering, RF sputtering, pulse DC sputtering, vapor deposition, CVD, or the like. The thickness of the Ru intermediate layer 5 is, for example, from about 15 nm to about 20 nm.

A non-magnetic layer 6 that includes an oxide is formed on the Ru intermediate layer 5. The oxide-containing non-magnetic layer 6,includes for example, a Co—Cr alloy and an oxide. The oxide-containing non-magnetic layer 6 may be also formed by, for example, plating, DC sputtering, RF sputtering, pulse DC sputtering, vapor deposition, CVD, or the like. The thickness of the oxide-containing non-magnetic layer 6 is, for example, from about 1 nm to about 5 nm.

A non-magnetic intermediate layer 33 includes the nickel alloy intermediate layer 4, the Ru intermediate layer 5, and the oxide-containing non-magnetic layer 6. The soft magnetic underlayer 31 and a perpendicular magnetic recording layer 32 to be described later are magnetically separated from each other mainly by the Ru intermediate layer 5 and the oxide-containing non-magnetic layer 6. Further, the nickel alloy intermediate layer 4 improves the crystal orientation of the Ru intermediate layer 5.

A granular layer 7, a non-magnetic layer 8, a granular layer 9, and a magnetic layer 10 that includes a continuous film are laminated on the oxide-containing non-magnetic layer 6 in this order. The perpendicular magnetic recording layer 32 includes the granular layer 7, the non-magnetic layer 8, the granular layer 9, and the magnetic layer 10.

In the granular layers 7 and 9, an oxide exists between, for example, a plurality of magnetic crystal grains. That is, the plurality of magnetic crystal grains are separated from each other by the oxide. The granular layers 7 and 9 may be also formed by, for example, plating, DC sputtering, RF sputtering, pulse DC sputtering, vapor deposition, CVD, or the like.

The magnetic crystal grains in the granular layer 7 are, for example, CoCrPt particles. In this case, for example, the ratio of the Cr atoms included in the magnetic crystal grains is from about 5% to about 15% of all the atoms forming the granular layer 7, the ratio of the Pt atoms is from about 11% to about 25%, and the remaining portion is Co. Further, the volume ratio of the oxide is, for example, from about 6% to about 13%. A titanium oxide, a silicon oxide, a chromium oxide, or a tantalum oxide, for example, is used as the oxide. A composite oxide including these oxides may be used as the oxide. The thickness of the granular layer 7 is, for example, from about 7 nm to about 10 nm.

The magnetic crystal grains in the granular layer 9 are, for example, CoCrPt particles. In this case, for example, the ratio of the Cr atoms included in the magnetic crystal grains is from about 7% to about 15% of all the atoms forming the granular layer 7, the ratio of the Pt atoms is from about 11% to about 17%, and the remaining portion is Co. Further, the volume ratio of the oxide is, for example from about 6% to about 13%. A titanium oxide, a silicon oxide, a chromium oxide or a tantalum oxide, for example, is used as the oxide. A composite oxide including these oxides may be used as the oxide. The thickness of the granular layer 9 is, for example, from about 5 nm to about 10 nm. Further, the magnetic anisotropy field (Hk) of the granular layer 9 is lower than that of the granular layer 7.

Note that it is not necessary that the magnetic crystal grains in the granular layers 7 and 9 be the Co—Cr—Pt particles, and the magnetic crystal grains of a Co—Cr—Pt-based alloy may be included therein. Further, magnetic crystal grains of a Co—Cr-based alloy including Pt, B, Cu, Ta may be included therein.

A non-magnetic metal layer having, for example, a Ru alloy that includes a ferromagnetic element is formed as the non-magnetic layer 8. For example, an alloy of Ru with Co, Ni, or Fe may be used as the material of the non-magnetic layer 8. The non-magnetic layer 8 may be also formed by, for example, plating, DC sputtering, RF sputtering, pulse DC sputtering, vapor deposition, CVD, or the like. The thickness of the non-magnetic layer 8 is set to such a thickness that magnetic coupling is formed between the granular layer 7 and the granular layer 9 (for example, from about 0.05 nm to about 1.5 nm). That is, ferromagnetic exchange coupling appears between the granular layers 7 and 9. Note that an alloy of an element such as Re, Cr, Rh, Ir, Cu, V and the like and a ferromagnetic element may be used as the material of the non-magnetic layer 8.

The magnetic layer 10 includes a Co—Cr—Pt-based alloy of, for example, Co—Cr—Pt—B, Co—Cr—Pt—Cu, Co—Cr—Pt—Ag, Co—Cr—Pt—Au, Co—Cr—Pt—Ta, Co—Cr—Pt—Nb, and the like. The ratio of the Cr atoms is from about 17% to about 22% of all the atoms forming the magnetic layer 10, the ratio of the Pt atoms is from about 11% to about 17%, and the remaining portion is Co and additive elements. Substantially no oxide is included in the magnetic layer 10, and a plurality of the magnetic crystal grains are in intimate contact with one another in the magnetic layer 10. The magnetic layer 10 may be also formed by, for example, plating, DC sputtering, RF sputtering, pulse DC sputtering, vapor deposition, CVD, or the like. The thickness of the magnetic layer 10 is, for example, from about 5 nm to about 10 nm. Note that any of a crystallized layer and an amorphous layer may be used as the magnetic layer 10. The magnetic anisotropy field of the magnetic layer 10 is lower than the magnetic anisotropy field of the granular layer 9.

A carbon protection layer 11 is formed on the magnetic layer 10. The carbon protection layer 11 may be formed by, for example, CVD, or the like. The thickness of the carbon protection layer 11 is, for example, from about 2.5 nm to about 4.5 nm. Further, a lubricant layer 12 is formed on the carbon protection layer 11. The lubricant layer 12 is formed by applying, for example, a lubricant. The thickness of the lubricant layer 12 is, for example, about 1 nm.

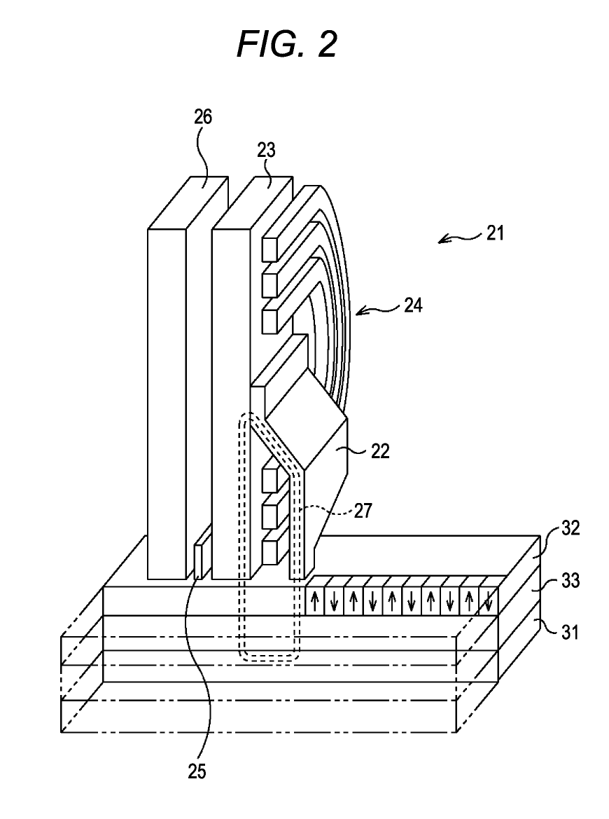

Data is written (recorded) to and read out (reproduced) from the perpendicular magnetic recording medium configured as described above using a magnetic head as shown in FIG. 2. A writing main magnetic pole 22, a return pole 23, and a coil 24 are disposed to the magnetic head 21 for the perpendicular magnetic recording medium. Further, a reading magneto-resistive effect element 25 and a shield 26 are also disposed to the magnetic head 21. The return pole 23 also acts as a shield to the magneto-resistive effect element 25. When data is written, a current is flown to the coil 24, and a magnetic flux 27 is formed through the main magnetic pole 22 and the return pole 23. At this time, after the magnetic flux 27 from the main magnetic pole 22 passes through the recording layer 6, it returns to the return pole 23 through the soft magnetic underlayer 31. Accordingly, the magnetization of the perpendicular magnetic recording layer 32 is changed to any of two directions (upper direction or lower direction) perpendicular thereto according to the direction of the magnetic flux for each recording bit.

As described above, in the example embodiment, the granular layers 7 and 9, which are magnetically separated from each other by the non-magnetic layer 8, are disposed to the perpendicular magnetic recording layer 32. Accordingly, it is possible to individually select the materials of the granular layers 7 and 9. The magnetic anisotropy fields of the granular layers 7 and 9 are properly regulated. That is, the granular layer 7 away from a surface includes a material having high magnetic energy, and the granular layer 9 near the surface includes a material having low magnetic energy. Therefore, the stability of recorded magnetization is kept by the granular layer 7. Further, since the magnetization reversal of the granular layer 9 is transmitted to the granular layer 7 through the non-magnetic layer 8, the magnetization reversal of the granular layer 7 is supported by the aforementioned magnetization reversal. As a result, the perpendicular magnetic recording layer 32 may obtain high overwrite characteristics in its entirety while securing a high magnetic anisotropy field. That is, thermal stability and the overwrite characteristics may be made compatible. Further, since the magnetic layer 10 is disposed on the granular layer 9, HDI (Head-Disk interface) characteristics, the control of magnetic characteristics, and electromagnetic conversion characteristics may be improved.

Further, in the example embodiment, the non-magnetic layer 8 includes the ferromagnetic element. Accordingly, when the thickness of the non-magnetic layer 8 is changed, the magnetization reversal magnetic field of the perpendicular magnetic recording layer 32 in its entirety is changed gently as compared with a case in which the ferromagnetic element is not included as also apparent from a result of experiments to be described later. This means that even if the thickness of the non-magnetic layer 8 is varied, the magnetization reversal magnetic field is less likely, if not unlikely, to be varied. Accordingly, the range of the thickness of the non-magnetic layer 8 (in which the magnetic coupling between the granular layers 7 and 9 may be improved) may be increased as compared with the case in which the ferromagnetic element is not included. Further, the thickness of the non-magnetic layer 8 (in which the magnetic coupling between the granular layers 7 and 9 may be improved) may be increased as compared with the case in which the ferromagnetic element is not included as also apparent from the result of the experiments to be described later. Therefore, the thickness of the non-magnetic layer 8 may be easily controlled. As described above, according to an example embodiment, there may be obtained the perpendicular magnetic recording medium which is excellent in thermal stability and the overwrite characteristics and suitable for mass production.

Note that although the thickness of the non-magnetic layer 8 changes according to the composition thereof, it may be set to be at least about 0.05 nm, or thicker yet at about 0.35 nm or more in consideration of mass production property. When the thickness of the non-magnetic layer 8 is less than about 0.05 nm, the thickness may not be easily controlled. The thickness may be particularly easily controlled when it is set to about 0.35 nm or more. In contrast, even if the thickness of the non-magnetic layer 8 exceeds about 0.45 nm, the characteristics are less changed, and thus a material may be wasted in this case.

Without being bound by theory, when the perpendicular magnetic recording medium described above is manufactured, it is sufficient to sequentially form the respective layers described above on the non-magnetic substrate 30. Further, it is preferable to remove surface projections, foreign substances, and the like using a polishing tape or the like after the lubricant layer 12 is formed.

According to the manufacturing method described above, there is provided a perpendicular magnetic recording medium in which the thermal stability and the overwrite characteristics may be made compatible and which is more suitable for mass production.

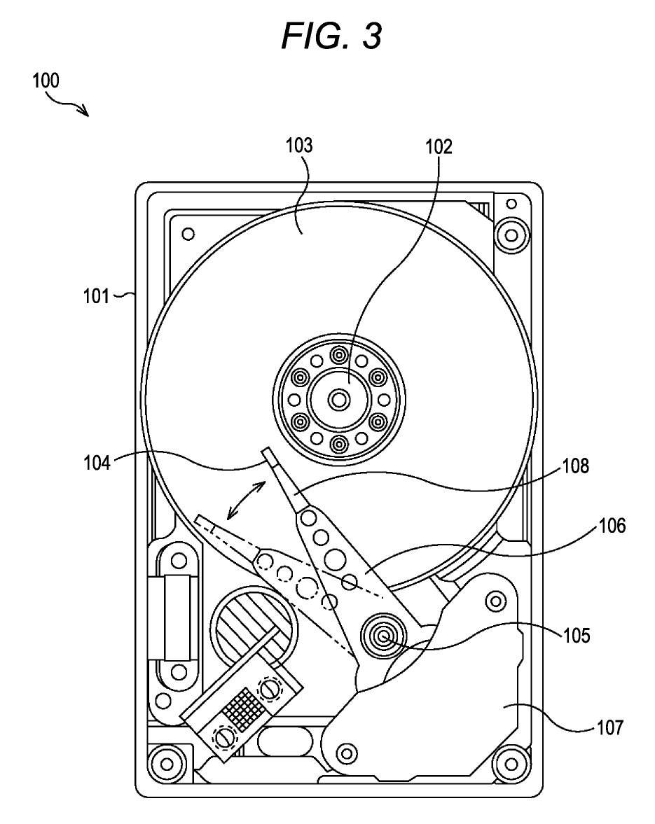

A hard disc drive (HDD) as an example of a magnetic storage device having the perpendicular magnetic recording medium according to an example embodiment described above is now explained here. FIG. 3 is a view showing an internal arrangement of a hard disc drive according to an example embodiment.

A housing 101 of the hard disc drive 100 accommodates a magnetic disc 103 which is mounted on a rotating shaft 102 and rotated thereby, a slider 104 on which a magnetic head for recording and reproducing information to and from the magnetic disc 103 is mounted, a suspension 108 for holding the slider 104, a carriage arm 106 to which the suspension 108 is fixed and which moves along the surface of the magnetic disc 103 about an arm shaft 105, and an arm actuator 107 for driving the carriage arm 106. The perpendicular magnetic recording medium according to an example embodiment described above is used as the magnetic disc 103.

Note that, thus far, example embodiments of the present invention have been described with reference to a perpendicular magnetic recording medium. However, it should be understood that such example embodiments are also applicable for a horizontal magnetic recording medium. Further, it is not necessary to employ the granular layers as the ferromagnetic layers coupled with each other by the non-magnetic layer 8.

Next, the experiments performed by the inventors will be explained.

(First Experiment)

In a first experiment, four specimens or samples of a magnetic recording medium were prepared according to the example embodiment described above, and one specimen was prepared by eliminating the non-magnetic layer 8 from the embodiment as a reference example A. Further, four specimens using a non-magnetic layer having only Ru in place of the non-magnetic layer 8 were prepared as a reference example B. That is, the reference example B had such a structure that the magnetic layer 10 was added to the conventional perpendicular magnetic recording medium disclosed in Japanese Patent Application Laid-Open No. 2006-48900. Note that the thicknesses of respective layers were set as shown in Table 1. Further, a Ru—Co alloy layer having a Co concentration of 35 atom % was used as the non-magnetic layer 8 in the experiment.

TABLE 1

| | Thickness (nm) |
|---|---|
| Soft magnetic layer 1 | 25 |
| Non-magnetic layer 2 | 0.5 |
| Soft magnetic layer 3 | 25 |
| Ni alloy intermediate layer 4 (Ni—W layer) | 8 |
| Ru intermediate layer 5 | 20 |
| Oxide-containing non-magnetic layer 6 | 3.5 |
| Granular layer 7 | 7.5 |
| Non-magnetic layer 8 | 0.25 |
| Granular layer 9 | 5 |
| Magnetic layer 10 | 7 |
| Carbon protection layer 11 | 3.5 |

Then, the coercive force Hc, the magnetization reversal magnetic field Hs, the write core width, the resolution, the overwrite characteristics, the side erase index, and VTM (Viterbi Trellis Margin) of these specimens were measured. A result of the measurement is shown in Table 2. The write core width shows a track width by which information may be accurately recorded. As shown in Table 1, the write core width having a smaller value may record information at a higher track density. The overwrite characteristics were evaluated by the ratio of the signal which is read when information was written at, e.g., 124 kBPI (kilobits/inch) to the signal which was read when information was written at, e.g., 495 kBPI. Table 1 shows that the value of the signal nearer to about −40 dB has better overwrite characteristics. Table 1 also shows that the side erase index nearer to about 0 makes side erase less likely, if not unlikely, to occur. VTM shows the error ratio of a signal corrected by Viterbi demodulation and is, e.g., proportional to the error rate.

TABLE 2

| | | | | | Overwrite | | |
|---|---|---|---|---|---|---|---|
| | Hc | Hs | Write core | | Char. | Side erase | |
| | (Oe) | (Oe) | width (μm) | Resolution (%) | (dB) | (dB) | VTM |
| Example | 4724 | 8384 | 0.1295 | 66.0 | −37.7 | −0.33 | 2.290 |
| | 4821 | 8339 | 0.1306 | 65.3 | −37.0 | −0.27 | 2.223 |
| | 4943 | 8569 | 0.1275 | 67.3 | −36.3 | −0.20 | 2.222 |
| | 5023 | 8748 | 0.1231 | 67.2 | −29.8 | −0.27 | 2.398 |
| Ref. | 4675 | 8134 | 0.1315 | 60.0 | −47.0 | −0.36 | 2.611 |
| example A | | | | | | | |
| Ref. | 4468 | 7904 | 0.1360 | 64.4 | −43.3 | −0.37 | 2.181 |
| example B | 4584 | 7832 | 0.1386 | 64.6 | −42.7 | −0.43 | 2.116 |
| | 4634 | 7951 | 0.1344 | 64.0 | −40.3 | −0.33 | 2.163 |
| | 4722 | 8132 | 0.1296 | 65.1 | −37.1 | −0.30 | 2.242 |

As shown in Table 2, the example could obtain electromagnetic conversion characteristics which are better than those of the reference example A and approximately as good as those of the reference example B. Thus, even if the material of the non-magnetic layer 8 includes the ferromagnetic element, the electromagnetic conversion characteristics are substantially not deteriorated as compared with a case in which the ferromagnetic element is not included.

(Second Experiment)

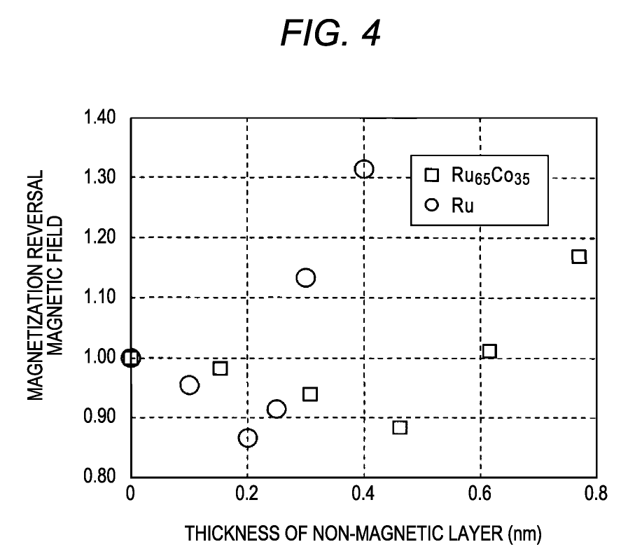

In a second experiment, the relation between the thickness of the non-magnetic layer between the granular layers and the magnetization reversal magnetic field Hs was investigated. A result of the investigation is shown in FIG. 4. In FIG. 4, a square shows a result of specimens in which the non-magnetic layer includes a Ru—Co alloy layer having the Co concentration of 35 atom %, and a circle shows a result of the specimens in which the non-magnetic layer includes a Ru layer (which is the reference example B). Further, the value of a vertical axis shows a value when standardization is made by the magnetization reversal magnetic field of the specimen in which the non-magnetic layer does not exist.

As shown in FIG. 4, the magnetization reversal magnetic field of the specimens using Ru65Co35 (that is, Ru concentration of 65 atom % and Co concentration 35 atom %) changes more gently than that of the specimens using Ru. This shows that even if the thickness of the non-magnetic layer is varied in a manufacturing process, the magnetization reversal magnetic field is less likely, if not unlikely, to be affected in the example embodiment. That is, because the magnetization reversal magnetic field of the example is stable, the example is suitable for mass production.

Further, the thickness of the non-magnetic layer of the example, in which the magnetization reversal magnetic field is minimized, is larger in the example embodiment than in the reference example B. Accordingly, the thickness, in which the exchange coupling between the granular layers is broken, is larger in the example embodiment than in the reference example B. Accordingly, because the thickness of the example for securing preferable coupling is larger than that of the reference example B, the non-magnetic layer having a desired thickness may be more easily obtained.

(Third Experiment)

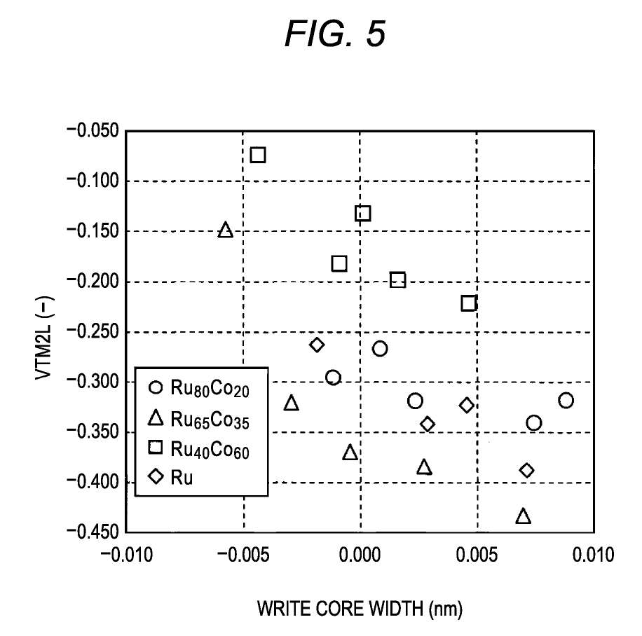

In a third experiment, the relation between the write core width and VTM was investigated by fixing the thickness of the non-magnetic layer between the granular layers to be, e.g., 0.36 nm. A result of the investigation is shown in FIG. 5. In FIG. 5, a circle shows a result of a specimen (sample) in which a non-magnetic layer includes a Ru—Co alloy layer having a Co concentration of 20 atom %, a triangle shows a result of a specimen (sample) in which a non-magnetic layer includes a Ru—Co alloy layer having a Co concentration of 35 atom %, a square shows a result of a specimen (sample) in which a non-magnetic layer includes a Ru—Co alloy layer having a Co concentration of 60 atom %, and a diamond shows a result of a specimen in which a non-magnetic layer includes a Ru layer (which is reference example B). Further, the values of a horizontal axis and a vertical axis show the difference of the write core width and VTM from those of the specimen in which the non-magnetic layer does not exist (which is reference example A).

As shown in FIG. 5, the specimens (examples) using Ru80Co20 or Ru65Co35 may obtain a result approximately the same as that of the specimen using Ru (reference example B). Further, the specimen (sample) using Ru40Co60 may obtain desired characteristics although the VTM thereof was somewhat higher than the reference example B. From the above result, when the Ru—Co alloy is used, the ratio of Co may be from about 20 atom % to about 55 atom %.

Many features and advantages of the embodiments of the invention are apparent from the detailed specification and, thus, it is intended by the appended claims to cover all such features and advantages of the embodiments that fall within the true spirit and scope thereof. Further, because numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A magnetic recording medium comprising:
a substrate;
a first ferromagnetic layer formed on the substrate;
a non-magnetic layer formed on the first ferromagnetic layer and including a ferromagnetic element; and
a second ferromagnetic layer formed on the non-magnetic layer,
the first ferromagnetic layer and the second ferromagnetic layer being magnetically coupled through the non-magnetic layer.

2. The magnetic recording medium according to claim 1, wherein the non-magnetic layer comprises a Ru alloy.

3. The magnetic recording medium according to claim 2, wherein the non-magnetic layer comprises a ferromagnetic element that includes one of cobalt, nickel, and iron.

4. The magnetic recording medium according to claim 2, wherein the non-magnetic layer comprises cobalt from about 20 atom % to about 55 atom % as the ferromagnetic element.

5. The magnetic recording medium according to claim 1, wherein:
the first ferromagnetic layer comprises a plurality of first magnetic crystal grains and a first oxide for separating the plurality of first magnetic crystal grains from one another; and
the second ferromagnetic layer comprises a plurality of second magnetic crystal grains and a second oxide for separating the plurality of second magnetic crystal grains from one another.

6. The magnetic recording medium according to claim 5, wherein the first magnetic crystal grains comprise CoCrPt particles, a ratio of the Cr atoms included in the first magnetic crystal grains is from about 5% to about 15% of all the atoms forming a first granular layer, and a ratio of the Pt atoms is from about 11% to about 25%, and a volume ratio of the first oxide in the first granular layer is from about 6% to about 13%.

7. The magnetic recording medium according to claim 5 wherein the second magnetic crystal grains comprise CoCrPt particles, a ratio of the Cr atoms included in the second magnetic crystal grains is from about 7% to about 15% of all the atoms forming a second granular layer, and a ratio of the Pt atoms is from about 11% to about 17%, and a volume ratio of the second oxide in the second granular layer is from about 6% to about 13%.

8. The magnetic recording medium according to claim 1, wherein the first oxide and the second oxide comprises at least one selected from the group consisting of a titanium oxide, a silicon oxide, a chromium oxide, and a tantalum oxide.

9. The magnetic recording medium according to claim 1, wherein the thickness of the non-magnetic layer is from about 0.05 nm to about 1.5 nm.

10. The magnetic recording medium according to claim 1, further comprising:
a soft magnetic underlayer interposed between the substrate and the first ferromagnetic layer; and
a non-magnetic intermediate layer for magnetically separating the soft magnetic underlayer from a recording layer having the first ferromagnetic layer, the non-magnetic layer, and the second ferromagnetic layer.

11. The magnetic recording medium according to claim 10, wherein the soft magnetic underlayer comprises:
a first soft magnetic layer;
a second non-magnetic layer formed on the first soft magnetic layer; and
a second soft magnetic layer formed on the second non-magnetic layer.

12. A magnetic storage device comprising:
a magnetic recording medium comprising:
a substrate;
a first ferromagnetic layer formed on the substrate;
a non-magnetic layer formed on the first ferromagnetic layer and including a ferromagnetic element and a second ferromagnetic layer formed on the non-magnetic layer, the first ferromagnetic layer being magnetically coupled with the second ferromagnetic layer through the non-magnetic layer; and
a magnetic head to record and reproduce information to and from the magnetic recording medium.

13. The magnetic storage device according to claim 12, wherein the non-magnetic layer comprises a Ru alloy.

14. The magnetic storage device according to claim 13, wherein at least one of the following circumstances is true:
the non-magnetic layer comprises a ferromagnetic element that includes one of cobalt, nickel, and iron; and
the non-magnetic layer comprises cobalt from about 20 atom % to about 55 atom % as the ferromagnetic element.

15. The magnetic storage device according to claim 12, wherein:
the first ferromagnetic layer comprises a plurality of first magnetic crystal grains and a first oxide for separating the plurality of first magnetic crystal grains from one another; and
the second ferromagnetic layer comprises a plurality of second magnetic crystal grains and a second oxide for separating the plurality of second magnetic crystal grains from one another.

16. The magnetic storage device according to claim 15, wherein at least one of the following circumstances is true:
the first magnetic crystal grains comprise CoCrPt particles, a ratio of the Cr atoms included in the first magnetic crystal grains is from about 5% to about 15% of all the atoms forming a first granular layer, and a ratio of the Pt atoms is from about 11% to about 25%, and a volume ratio of the first oxide in the first granular layer is from about 6% to about 13%; and
the second magnetic crystal grains comprise CoCrPt particles, a ratio of the Cr atoms included in the second magnetic crystal grains is from about 7% to about 15% of all the atoms forming a second granular layer, and a ratio of the Pt atoms is from about 11% to about 17%, and a volume ratio of the second oxide in the second granular layer is from about 6% to about 13%.

17. The magnetic storage device according to claim 12, wherein the first oxide and the second oxide comprises at least one selected from the group consisting of a titanium oxide, a silicon oxide, a chromium oxide, and a tantalum oxide.

18. The magnetic storage device according to claim 12, wherein the thickness of the non-magnetic layer is from about 0.05 nm to about 1.5 nm.

19. The magnetic storage device according to claim 12, further comprising:
a soft magnetic underlayer interposed between the substrate and the first ferromagnetic layer; and
a non-magnetic intermediate layer for magnetically separating the soft magnetic underlayer from a recording layer having the first ferromagnetic layer, the non-magnetic layer, and the second ferromagnetic layer.

20. The magnetic storage device according to claim 19, wherein the soft magnetic underlayer comprises:
a first soft magnetic layer;
a second non-magnetic layer formed on the first soft magnetic layer; and
a second soft magnetic layer formed on the second non-magnetic layer.
